(19) United States
(12) Patent Application Publication
(10) Pub. No.: US 2017/0286603 A1
(43) Pub. Date: Oct. 5, 2017

(54) COMPLETE HEALTH CARE KIT

(71) Applicant: Scott Charles Farmer, Nixa, MO (US)

(72) Inventor: Scott Charles Farmer, Nixa, MO (US)

(21) Appl. No.: 15/083,521

(22) Filed: Mar. 29, 2016

(51) Int. Cl. G06F 19/00

(52) U.S. Cl. CPC G06F 19/325

(57) ABSTRACT

A method, apparatus, system, and computer-readable medium storing computer-executable instructions for providing a health care kit for a patient suffering from a disease, the method comprising: receiving data from the patient corresponding to symptoms of the disease associated with the patient; medically educating the patient concerning the symptoms, compiling a diary-based health care kit adapted to enable the patient to intelligently discuss treatment options with a clinician/physician/health care provider.

### BACKGROUND OF THE INVENTION

The present invention relates to a decision-making tool which utilizes patient and provider technology to provide a complete health care kit.

There is a need for a system that educates and guides both patient and physician/clinician/health care provider and enables both to arrive at mutually approved decisions as to which diagnostic and treatment tools to employ, and when, in a particular disease or pathology state.

### SUMMARY OF THE INVENTION

An embodiment of the invention relates to an enhanced medical treatment system which (1) seeks input from the patient and the clinician/physician/health care provider about the medical problems encountered by the patient, (2) stores and analyzes this information, (3) educates the patient about his/her medical problems, and (4) seeks to guide the clinician/physician/health care provider to a correct diagnosis and treatment of the complaint. The system stores all of this information in diary form, so that a continuous record of the patient's visits and problems is kept on file and the physician is able to utilize the medical history to solve the patient's current problems, and the patient is kept up to date as to his/her treatment and prognosis. With this system in place the medical establishment will be able to improve health care delivery to the patients and be able to better manage the process of the providing health care while enabling the patient to participate in the process in a significant and meaningful way. Furthermore, this system will also lower the cost of providing health care without compromising on the quality of health care.

These and other features, aspects and advantages of the present invention will become better understood with reference to the following drawings, description and claims.

### BRIEF DESCRIPTION OF THE DRAWINGS

FIG. 1 is a schematic view of an embodiment of the invention.

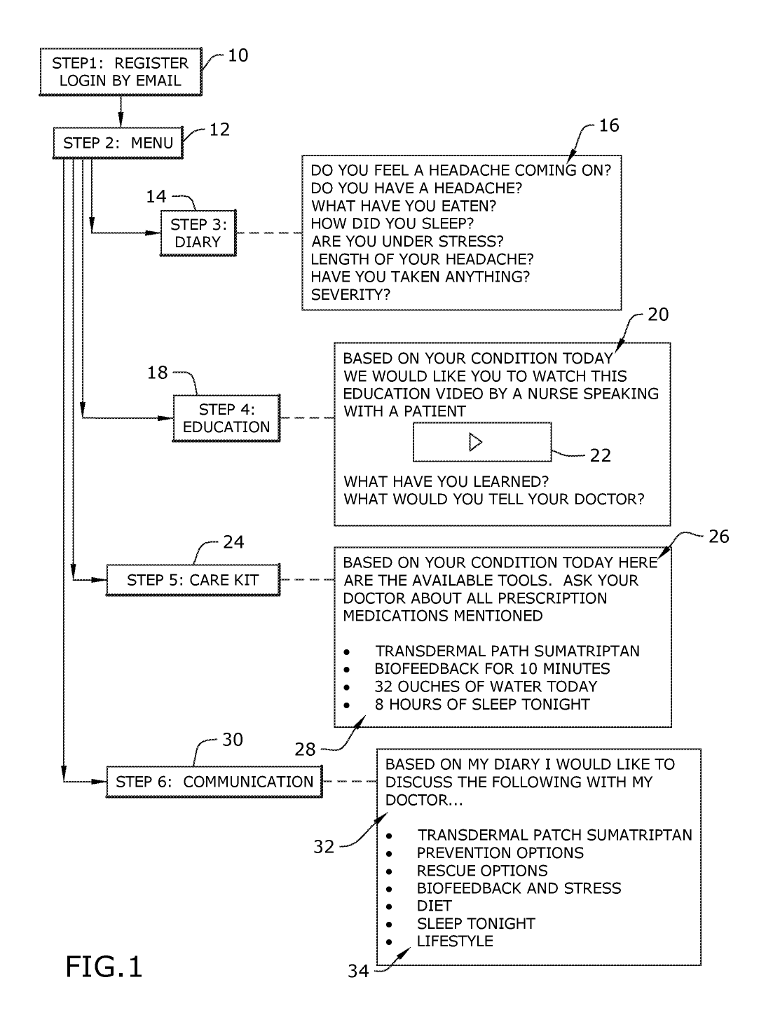

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention provides the education and tools available, both non-pharmacological and pharmacological for the patient to choose from in partnership with their clinician/physician/health care provider to provide a complete health care kit specifically designed for that patient.

More particularly, the system of the invention educates and guides patient and clinician/physician/health care provider on when to use what tool/diagnosis based on the disease stage and symptoms. It tracks to see what works and when for that specific patient and stores that information in reproducible diary form for the convenience of both the patient and clinician/physician/health care provider.

One embodiment of the invention concerns a method of providing a health care kit for a patient suffering from a disease, the method comprising: receiving data from the patient corresponding to symptoms of disease associated with the patient; medically educating the patient concerning the symptoms, compiling a diary-based health care kit adapted to enable the patient to intelligently discuss treatment options with a clinician/physician/health care provider.

Another embodiment of the invention relates to an apparatus comprising: a computer, the computer comprising a memory and a processor, where the processor executes computer-executable instructions in the memory to perform the method described above.

A further embodiment of the invention comprises a system comprising: a computer, the computer comprising a memory and a processor, wherein the processor executes computer-executable instructions in the memory for performing the method described above.

A still further embodiment of the invention comprises a computer-readable medium storing computer-executable instructions configured to cause a processor to perform the above-described method.

Those skilled in the art will appreciate that the term, “disease”, as employed herein refers to a particular abnormal condition, a disorder of a structure or function, that affects part or all of an organism, often construed as a medical condition associated with specific symptoms and signs.

Referring to the drawing, a preferred embodiment of the invention comprises a method, computer system, and computer-readable medium that embraces the following steps:
1. User (patient) registration/login (10).
2. Selection of Menu item (12).
3. User inputs data concerning symptoms of disease (16) into diary (14).
4. User is educated (18) by watching a video (22) containing information (20) concerning the symptoms.
5. User is provided with a health care kit (24) containing information (26) concerning available tools (28) for alleviating symptoms.
6. Communication (30) with clinician/physician/health care provider as to which items (34) listed in display (32) user wishes to discuss.

The present invention is illustrated in further details by the following non-limiting example. The example is provided for illustration only and should not be construed as limiting the scope of the invention.

### EXAMPLE

Utilizing the method, computer system and computer-readable medium of the invention described in the drawing, the user/patient registers and logs in (10) to access the main menu (12) from which the diary option (14) is selected. Therein, the user inputs answers to a list of questions (16):
A] DO YOU FEEL A HEADACHE COMING ON?
B] DO YOU HAVE A HEADACHE?
C] WHAT HAVE YOU EATEN?
D] HOW DID YOU SLEEP?
E] ARE YOU UNDER STRESS?
F] LENGTH OF YOUR HEADACHE?
G] HAVE YOU TAKEN ANYTHING?
H] SEVERITY?

The user then proceeds to the education option (18) wherein the user might be instructed to watch a video (22) of a health care practitioner speaking with a patient about the user's symptoms (20), and is asked to input what the patient has learned therefrom and what the patient would tell the clinician/physician/health care provider.

From there the user would open the health care kit option (24) where, based on the above, a display (26) listing the available tools (28):
A] TRANSDERMAL PATH SUMATRIPTAN
B] BIOFEEDBACK FOR 10 MINUTES
C] 32 OUCHES OF WATER TODAY
D] 8 HOURS OF SLEEP TONIGHT

Next, the user would proceed to the communication option (30) wherein a display (32) sets forth the items (34) for discussion with the clinician/physician/health care provider:
A] TRANSDERMAL PATCH SUMATRIPTAN
B] PREVENTION OPTIONS
C] RESCUE OPTIONS
D] BIOFEEDBACK AND STRESS
E] DIET
F] SLEEP TONIGHT
G] LIFESTYLE

It should be understood, of course, that the foregoing relates to exemplary embodiments of the invention and that modifications may be made without departing from the spirit and scope of the invention as set forth in the following claims.

What is claimed is:

1. A method of providing a health care kit for a patient suffering from a disease, the method comprising: receiving data from the patient corresponding to symptoms of the disease associated with the patient; medically educating the patient concerning the symptoms, compiling a diary-based health care kit adapted to enable the patient to intelligently discuss treatment options with a clinician/physician/health care provider.

2. The method of claim 1, including the step of communicating with said clinician/physician/health care provider as to treatment of said disease.

3. An apparatus comprising: a computer, the computer comprising a memory and a processor, wherein the processor executes computer-executable instructions in the memory to perform the method of claim 1.

4. A system comprising: a computer, the computer comprising a memory and a processor, wherein the processor executes computer-executable instructions in the memory for performing the method of claim 1.

5. A computer-readable medium storing computer-executable instructions configured to cause a processor to perform the method of claim 1.
